(19) United States
(12) Patent Application Publication
(10) Pub. No.: US 2008/0010337 A1
(43) Pub. Date: Jan. 10, 2008

(54) ANALYSIS AND SELECTIVE DISPLAY OF RSS FEEDS

(75) Inventors: Eric Hayes, Tigard, OR (US); Sandeep Natarajan, Portland, OR (US)

Correspondence Address: STOEL RIVES LLP, 900 SW FIFTH AVENUE, SUITE 2600, PORTLAND, OR, 97204-1268, US

(73) Assignee: Attensa, Inc., Portland, OR (US)

(21) Appl. No.: 11/775,150

(22) Filed: Jul. 9, 2007

Related U.S. Application Data
(60) Provisional application No. 60/819,270, filed on Jul. 7, 2006.

(51) Int. Cl. G06F 15/16

(52) U.S. Cl. 709/202

(57) ABSTRACT

An RSS reader ranks articles and RSS feeds based on monitoring user interactions with each article. In an enterprise version, ranking can reflect the interactions of multiple users with RSS feeds and articles. Monitored user interactions can include reading an article, tagging, forwarding, emailing and the like.

### RELATED APPLICATIONS

This application is a non-provisional of U.S. Provisional Application No. 60/819,270 filed Jul. 7, 2006 and incorporated herein by this reference.

### TECHNICAL FIELD

Internet communications; and more specifically digital information “feeds” to which a user can subscribe to receive automatically updated information in text, audio, video or other formats, and “readers” for using and managing such feeds.

### BACKGROUND

Knowledge workers use RSS Feeds and the like to keep track of dynamic information. These workers subscribe to hundreds of feeds of varying importance in which some feeds provide more information than others. A typical Knowledge Worker would want to arrange these feeds in their order of importance so that he/she can devote an appropriate amount of time and attention to reviewing and handling them. With hundreds of feeds, the task of ordering or prioritizing feeds becomes cumbersome. Thus is would be advantageous to automate a process of ordering the feeds and also the articles that these feeds contain.

### SUMMARY

Thus it would be advantageous to automate a process of ordering the feeds and also the articles that these feeds contain. This is facilitated with the help of various novel features disclosed herein, including Ranking and Prioritization.

Ranking in general helps the user to automatically order his/her feeds from most important to least important by automatically recording the amount of “attention” the user has given to the feed. “Attention” in this context is reflected by user interactions, for example, the amount of time a user spends reading a given feed/article, and other actions taken by the user such as forwarding an article, “starring” or otherwise marking it for later reference, printing it, etc. Priority helps the user by predicting which feed/article he/she is most likely to read next based on his/her past behavior.

Various embodiments of the present invention can provide one or more following benefits:
It shifts the burden of identifying important information from user to software.
It predicts what the user is going to read next thus bringing information to the user when he/she needs it.
It also helps the user identify what he/she has been paying most/least attention to.

Additional aspects and advantages will be apparent from the following detailed description of preferred embodiments, which proceeds with reference to the accompanying drawings.

### BRIEF DESCRIPTION OF THE DRAWINGS

FIG. 1 shows a functional block diagram illustrating one embodiment for practicing the invention in a non-enterprise system.

FIG. 2 illustrates one example of a scheme to capture and store various types of user attention data.

FIG. 3 shows a logical flow diagram illustrating one embodiment of a process of ranking articles in an RSS feed.

FIG. 4 shows a diagram illustrating one embodiment of a user profile that can be created and stored for each user.

FIG. 5 is a chart illustrating possible factors or “scores” for calculating a content-based rank of an article, and examples of relative weights of each score.

FIG. 6 shows a chart illustrating one embodiment for calculating a source-based rank of an article.

FIG. 7 shows a functional block diagram illustrating one embodiment for practicing the invention in an enterprise system.

FIG. 8 shows one embodiment of the graphical user interface of a feed reader that allows users to rank articles according to article attention rank, feed attention rank, or feed schedule rank.

### DETAILED DESCRIPTION OF PREFERRED EMBODIMENTS

In this application, “RSS” refers broadly to the formatting standards and related technologies used to distribute syndicated content from an information provider to multiple subscribers. The term RSS applies to multiple standards, including Real Simple Syndication, RDF Site Summary, and Rich Site Summary. Typically, information providers create an XML web page that contains a headline, content, and metadata for each published item. This XML web page is called the RSS feed. RSS feeds act as information streams that users subscribe to in order to receive syndicated content. RSS readers, also known as RSS aggregators, fetch and display updated information from feeds. Since users can subscribe to hundreds of feeds, they need a way to efficiently sort the information and find the content most important to them. Although this application focuses on RSS feeds, it also applies to ATOM and other web content syndication protocols. Further, the technology in this application can be used across multiple languages. We refer to a “user” to mean one who receives and uses articles provided to her by RSS feeds or the like.

The technology described in this application performs at least three main functions: (1) it collects and processes articles from one or more RSS feeds; (2) it ranks articles or feeds in relation to each other to reflect relative importance to the user, and (3) monitors user interaction with the articles and feeds and dynamically recalculates the rankings. In one embodiment, aspects of the invention can be implemented into a software “reader” that executes on the user's PC, PDA, cell phone or the like. We refer to such devices as a “client.” We use the term “article” herein and in the claims very broadly to include all types of content or media that may be transmitted by a feed over a network. That said, some of the methods disclosed herein require at least a minimum of textual metadata as explained below.

An enterprise version of this technology in a preferred embodiment adds to steps (2) and (3) by calculating the ranking of a feed or article as a function of multiple users' interactions with that specific feed or article, as further explained below.

Users can choose to display the processed articles on a client device by a content-based rank, a source-based rank, or a schedule-based rank. The content-based rank is determined by how often the user interacted with other articles with similar content to the article being ranked. The source-based rank is determined by how often the user interacted with other articles from the same RSS feed as the article being ranked. The schedule-based rank is determined by what feeds the user is most likely to read on a certain day and at a certain time.

Processing Articles

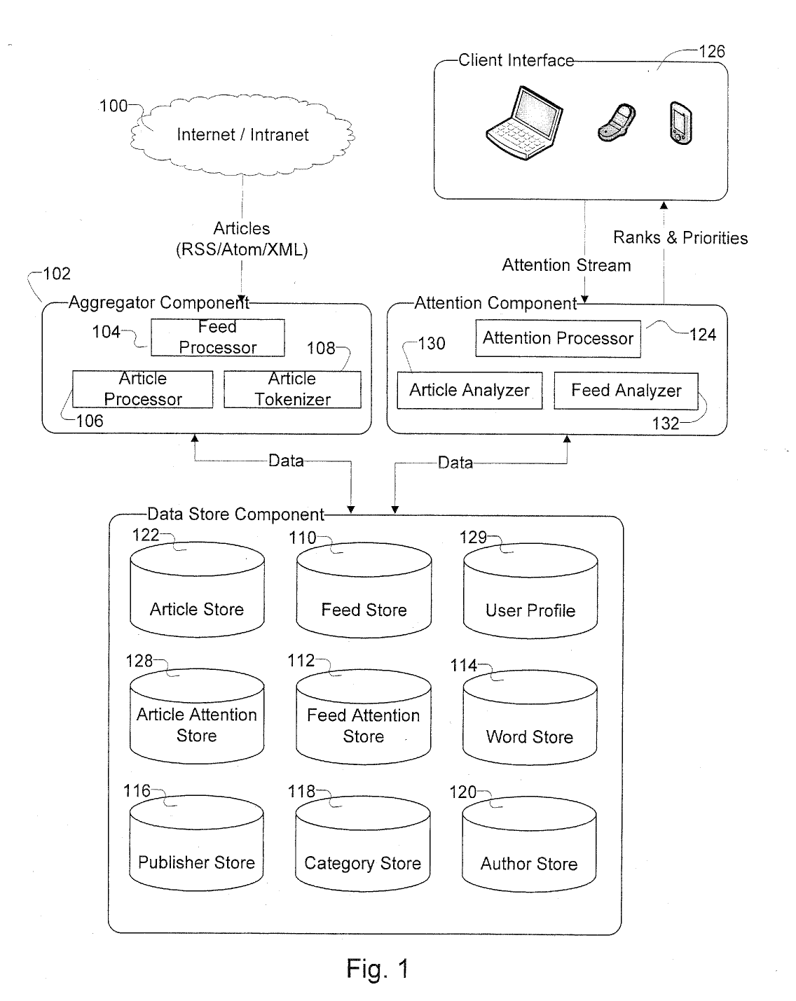

FIG. 1 shows the software components of one embodiment of the invention in a reader. An article in an RSS feed travels from an information provider via a network [100] to the aggregator component [102] of the software. This aggregator component processes the feed containing the article, processes the article, and tokenizes the article.

The feed processing component [104] collects information regarding the source of the feed and the time at which the feed's new article arrived. The component then stores the updated feed information in the feed store [110] and the feed attention store [112]. The preferred embodiment of the feed store [110] contains a unique identifier for every feed the user currently subscribes to or has subscribed to in the past, and the number of articles each feed has provided to the software. The preferred embodiment of the feed attention store [112] contains statistics on user attention paid to each feed, as well as the time at which the feed was last updated with a new article.

One preferred embodiment of the article processing component [106] first reduces each word in the article's content to its root form, generally by removing suffixes and plural forms. The processing component also identifies and removes trivial words from the article. Expected trivial words include “the,” “at,” and “is.” In one embodiment, the component identifies trivial words by determining which words occur most frequently across the articles processed by the software. The frequency of each word processed by the software is held in a word store [114], further described below.

A presently preferred embodiment of the word store [114] contains, for each root word collected from previously processed articles, the following data: (1) a unique number id, (2) appearance count, (3) frequency weight, (4) read count, (5) tag count, (6) email count, (7) click-through count, and (8) attention weight. Not all of this data is necessary in all embodiments. The appearance count represents the number of times a variation of the root word has appeared in an article's content. Note, an article's content includes its title. The frequency weight is a normalized value between zero and one, representing how often variations of the root word appeared in articles processed by the software. The read count represents the number of times an article containing a variation of the root was read by the user. The tag count represents the number of times an article containing a variation of the root was labeled by the user. The email count represents the number of times an article from the publisher was emailed by the user. The click-through count represents the number of times the user “clicked-through” an article. A user clicks-through an article if she follows a link presented in the article to another HTML page, or follows the article to the main web page distributing the article.

To find the most frequently used words, the article processing component [106] increments the appearance count and recalculates the frequency weight of each root word in the article. If a root in the article is not already in the word store [114], the root is added to store. In the preferred embodiment, a word with a frequency weight over 0.7 is considered trivial, and is discarded from the article. An alternative embodiment can identify trivial words in an article by comparing that article to a list of pre-determined trivial words.

The article processing component also processes the metadata associated with each article. In the preferred embodiment, the component extracts the publisher tag, category tag and author tag, and keeps track of them in the publisher store [116], category store [118], and author store [120], respectively. Other metadata can be processed in similar fashion.

The preferred embodiment of the publisher store [116] contains, for each publisher processed by the software, the following data: (1) a unique publisher identifier, (2) the publisher name, (3) appearance count, (4) frequency weight, (5) read count, (6) tag count, (7) email count, (8) click-through count, and (9) attention weight. “Publisher” refers to an entity responsible for making a resource or article available. Examples of a publisher include a person, an organization, or a service. It is not synonymous with a feed, as one publisher may provide multiple feeds.

The preferred embodiment of the category store [118] contains, for each category processed by the software, the following data: (1) a unique category identifier, (2) category name, (3) appearance count, (4) frequency weight, (5) read count, (6) tag count, (7) email count, (8) click-through count, and (9) attention weight. The preferred embodiment of the author store [120] contains, for each author of an article processed by the software: (1) a unique author identifier, (2) author name, (3) appearance count, (4) frequency weight, (5) read count, (6) tag count, (7) email count, (8) click-through count, and (9) attention weight. The unique metadata identifiers (publisher, category and author) preferably are numeric identifiers (“number id”).

Next, the article tokenizer component [108] replaces each remaining word (those not stricken) in the article with the word's corresponding unique number id from the word store [114]. In addition, the article tokenizer component [108] replaces each element (field) of metadata with the corresponding unique number id associated with that element of metadata in the publisher store [116], category store [118], or author store [120]. This “tokenized” article is then stored in the article store [122]. The preferred embodiment of the article store [122] contains an id for each processed article, an id for the source feed of the article, and the tokenized article, where the tokenized article comprises numbers representing each piece of metadata and each non-trivial word in the content. (The id for the source feed is the same as the that stored in the feed store [110] described above.)

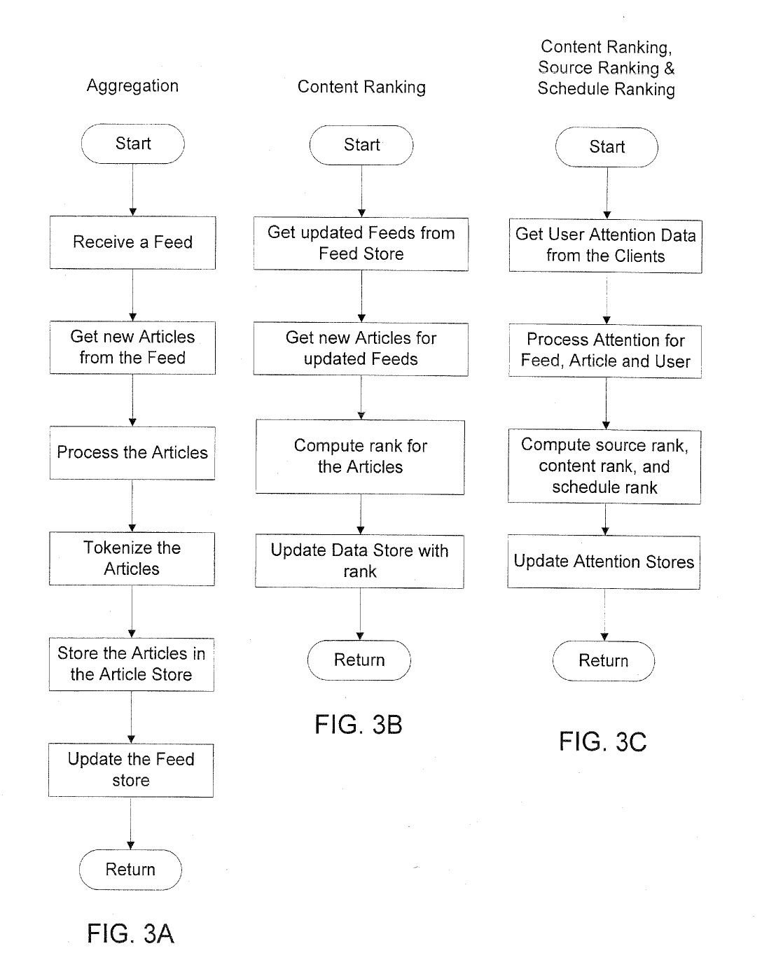

The preferred article aggregation methodology is summarized in FIG. 3A. Note that FIG. 3A is just a preferred embodiment of the methodology. The steps in FIG. 3A can be performed in a different order—the feed store can be updated before the articles are preprocessed, for example.

Monitoring User Attention

Articles and feeds can be ranked based on how much attention the user has paid to similar articles and feeds in the past. The user's attention serves as a proxy or an indicator of how important the content of an article is to the user. By ranking the articles based on the previously collected user attention information, the software will be able to identify the articles that the user would be most interested in reading.

The software monitors user attention and dynamically adjusts the article and feed rankings as a function of the user attention. As shown in FIG. 1, the attention processor component [124] collects user attention data from the client interface [126]. Each time the user interacts with an article or feed displayed to the user on a client device, the software collects data regarding the interaction.

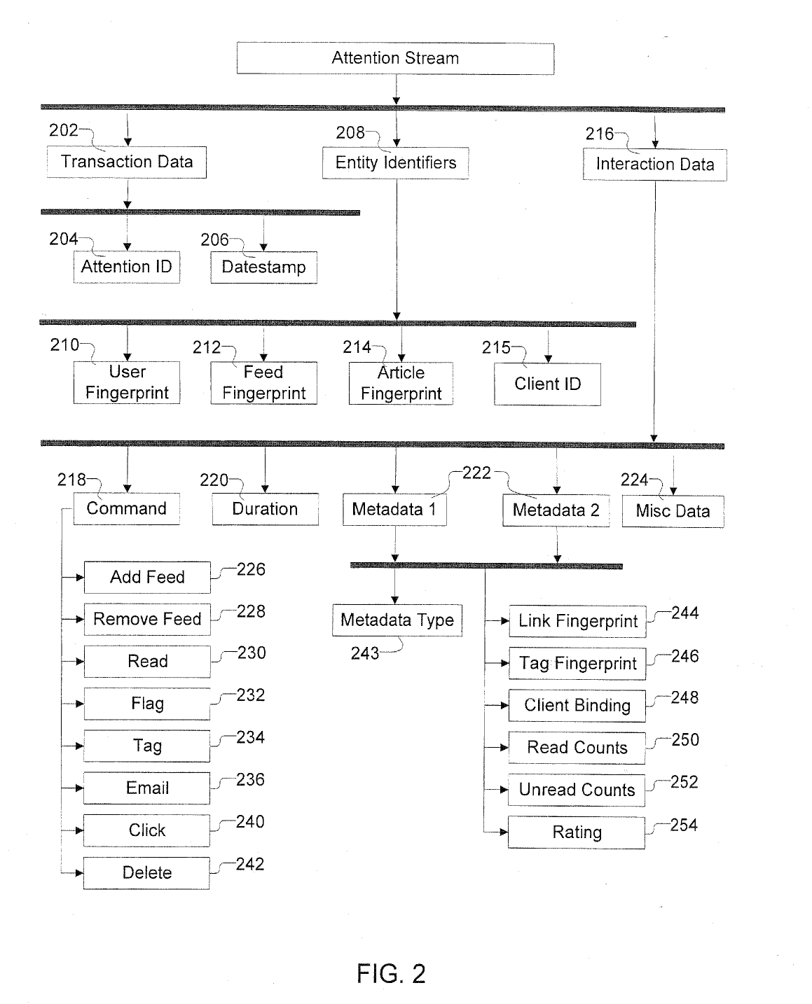

In the preferred embodiment, the attention processor component [124] collects three main types of data for each user interaction: transactional data, identity data, and interaction data. FIG. 2 illustrates each kind of data collected. The transactional data [202] includes a unique id for the interaction [204] and a date-stamp [206]. The date-stamp includes the day and time of the interaction. The identity data [208] collected includes a user id or “fingerprint” [210], feed id [212], article id [214], and client device id [215]. The interaction data [216] includes the nature of the interaction (“command”) [218], and the duration of that interaction [220], as well as additional metadata [222] and data [224] regarding the interaction.

In the preferred embodiment, the software monitors the following types of user actions: adding a new feed [226], removing a feed [228], reading an article [230], flagging an article [232], tagging an article [234], emailing an article [236], clicking through an article [240], or deleting an article [242]. The preferred embodiment also collects metadata regarding the user action, such as the link to which the user clicked-through [244], the label the user assigned to the article [246], the client device used to interact with the feeds [248], the number of times the article has been read [250], the number of times an article has remained unread [252], and any rating assigned to the article [254].

In the preferred embodiment, a user “reads” an article when she clicks the article title to open a complete version of the article. The complete article may be stored on the user's computer (or other client device), or on the web server distributing the article. The reading duration time ends when the user clicks on another article or closes the software application.

After collecting the user attention data, the attention processor component [124] updates the word store [114], publisher store [116], category store [118], author store [120], article attention store [128], and feed attention store [112] to reflect the attention paid by the user. For example, each time the user reads an article, the read count for the feed containing the article is incremented in the feed attention store [112]; the read count for each metadata element associated with the article is incremented in the publisher store [116], category store [118], and author store [120] (and or other metadata element stores); and the read count for each non-trivial word in the content of the article is incremented in the word store [114]. In addition, the fields in the article attention store [128] and user profile [129] are modified appropriately.

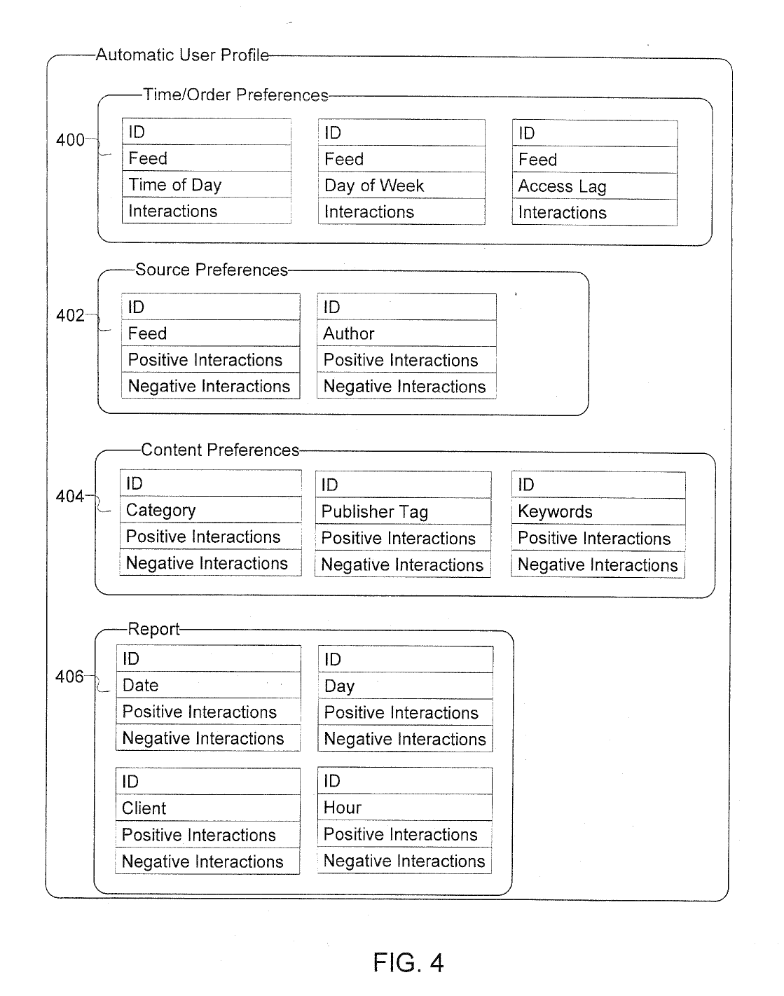

In the preferred embodiment, the article attention store [128] contains, for each processed article: an article id, the content-based rank, whether or not the article has been read, when the article was read, whether or not the article has been deleted, and when the article was received from the RSS feed. In the preferred embodiment, the user profile contains the user preferences for article content, feed source, and schedule. FIG. 4 illustrates a preferred embodiment for the user profile. The profile includes the user's time and order preferences [400], source preferences [402], and article content preferences [404]. The user profile also contains a report [406] of the positive and negative user interactions with an article or feed. Positive user interactions may include tagging or emailing an article. Negative user interactions may include deleting an article. User preferences may be inferred from the stored data and processes described above, based on user actions.

Once the stores have been updated, the article analyzer component [130] can re-calculate the content-based rank for each displayed article [128]. And the feed analyzer component [132] can re-calculate the source-based rank and the schedule-based rank for each displayed feed. The ranking process is described below.

Ranking Articles

In the preferred embodiment, users can choose to display a list of the processed articles by a content-based rank, a source-based rank, or a schedule-based rank, or by a combination of these or other factors. The selection can be done, for example, in a pull-down menu, radio button, etc in a graphical user interface displayed on the client device. User preferences or profile may be used to determine a default choice; or, a user's last display selection can be made persistent.

An article's content-based rank is determined generally by how frequently, or for how long, the user has paid attention to other articles that have the same words, or some of the same words, in their content and or metadata. An article's source-based rank is determined generally by how frequently, or for how long, the user has paid attention to other articles from the same feed. An article's schedule-based rank is determined generally by which feeds the user usually pays attention to on the same day and at the same time as the article currently being ranked and listed.

For example, if a feed X is ranked the highest feed in a source-based rank or a schedule-based rank, then, in the preferred embodiment, all the new articles from feed X will appear at the top of the user interface. And the articles within feed X will be listed in the order in which they were received by the software, with the newest articles on top. If the user chooses content-based ranking, the listing of articles shown in her client device screen display is re-ordered on that basis.

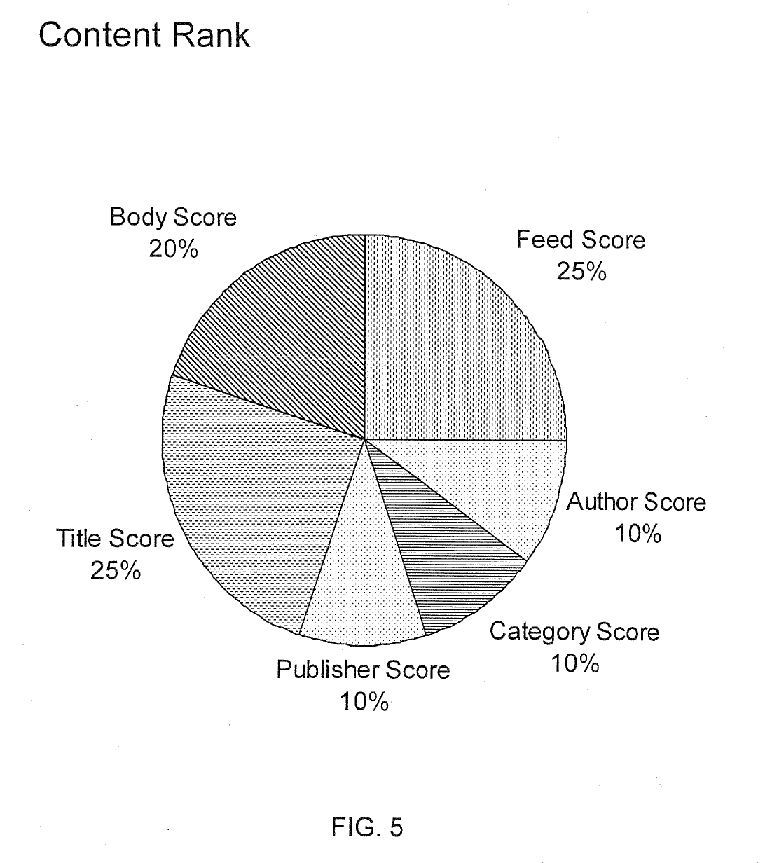

The content-based ranking creates an article rank as a function of the attention previously paid by the user to the words in the article's content or elements of the article's metadata. FIG. 5 illustrates the preferred factors and ratios when calculating the content rank. In a presently preferred embodiment, the software uses the following equation to calculate the content-based rank: (The star * or asterisk * is used to indicate the multiplication operator.)
Article content rank=(FeedScore*25%)+(AuthorScore*10%)+(CategoryScore*10%)+(PublisherScore*10%)+(ArticleTitleScore*25%)+(ArticleBodyScore*20%)

In the preferred embodiment, the score for each of the above factors (Feedscore, AuthorScore, etc.) is calculated using the following equation: [symbol]
Score=(ReadWeight*40%)+(TagWeight*20%)+(EmailWeight*20%)+(ClickThroughWeight*20%)

In one embodiment, the weight for each of the above attention factors (ReadWeight, TagWeight, etc.) is calculated using the following equation: InteractionWeight=1/(1+log₁₀(Total Number of Interactions/Interaction Count)). In the previous equation, the Total Number of Interactions is the total number of all types of user interactions with the article (examples are reading, tagging, emailing, etc.) and the Interaction Count is the number of one specific type of interaction with the article. This formula conveniently scales or normalizes each user interaction weight to a relative value between 0 and 1. To take a simple example, if there are a total of 8 interactions with an article, and 6 of those are emailing interactions, and 2 are tagging interactions, then the EmailWeight according to the above illustrative formula would be calculated as=1/(1+log₁₀(Total Number of Interactions/Interaction Count))=1/(1+log₁₀(8/6))=1/(1+log₁₀(1.334))=1/(1.125)=0.889.

The specific percentages or weighting factors shown here are merely illustrative. In various embodiments, they may take different values. In some embodiments, the user may be able to adjust these percentages to suit her own preferences. She may wish to adjust them based on experience.

Source-Based Ranking

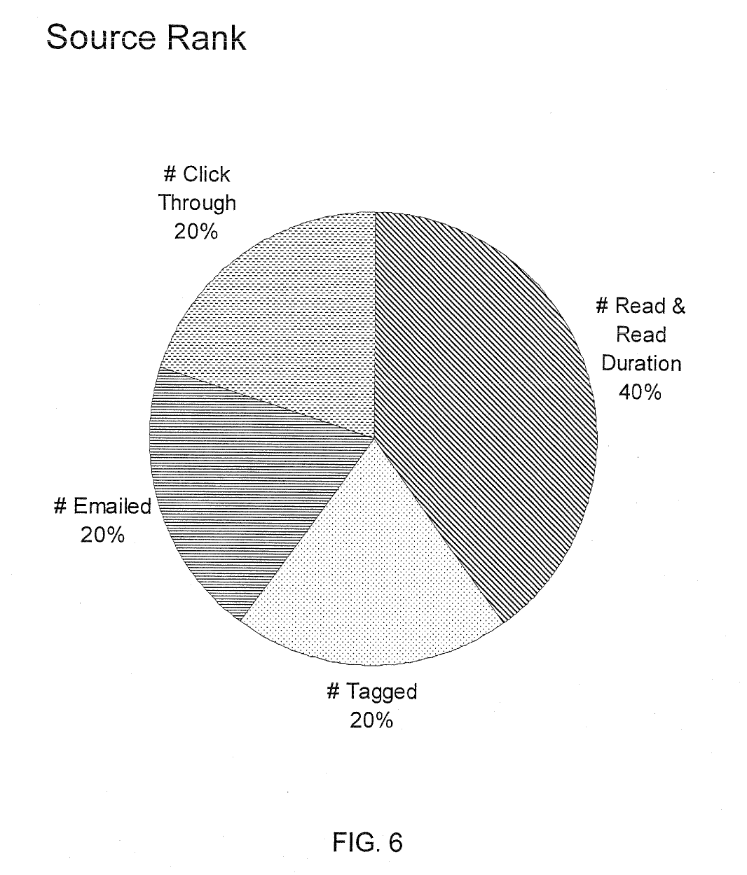

In general, source-based ranking creates an article rank as a function of the attention previously paid by the user to other articles from the same feed. All articles from the same feed will have the same source-based rank. FIG. 6 illustrates the preferred factors and ratios when calculating the source rank. In the preferred embodiment, the software uses the following equation to calculate the source-based rank:

Source rank=(ReadWeight*40%)+(TagWeight*20%)+(EmailWeight*20%)+(ClickThroughWeight*20%). Each weight is calculated as specified for the content-based ranking. Again, these specific values are a good starting point, but they are not critical, and different users may have different preferences.

The schedule-based ranking considers the time and order in which the user paid attention to articles. Each feed is given a schedule-based rank depending on how often the user reads that feed during a certain day and time. For example, a user might prefer consuming all work-related feeds between 8 am and 5 pm between Monday and Friday. In addition, the user might prefer to read her friends' feeds on Sunday morning. The software captures the user's interaction preferences and builds a user profile. The software then uses this profile to prioritize the feeds. All articles within the same feed will have the same schedule-based ranking. In one embodiment of the invention, the following information is tracked regarding each field, and used to create a schedule rank:

Feed status: (a) read only when the feed has new articles, (b) read feed even when there are no new articles, or (c) no preference.

Order: (a) read first before any other feed, (b) read last after all other feeds have been read, or (c) no preference.

Access Lag: (a) read as soon as download, (b) read once a day, (c) read once a week, or (d) no preference.

Weekend: (a) read only on weekdays, (b) read only on weekends, or (c) no preference.

Read Percentage: (a) read everything, (b) read only a percentage of articles, or (c) no preference.

Consumption Frequency: (a) read only once a day, (b) read more than once a day, or (c) no preference.

Context Switch: (a) continually read a feed when there are unread articles, (b) context switch between feeds, or (c) no preference.

The preferred ranking methodology is summarized in FIGS. 3B and 3C. FIG. 3B illustrates the initial calculation of the content rank for a new article. FIG. 3C illustrates adjusting the content rank, source rank and schedule rank based on monitored user attention.

In one embodiment, a Naïve Bayesian Network can be used to calculate the schedule-based rank. A naive Bayes classifier in general is a simple probabilistic classifier based on applying Bayes' theorem with strong (naive) independence assumptions. Details are know to those skilled in the art.

Enterprise Version

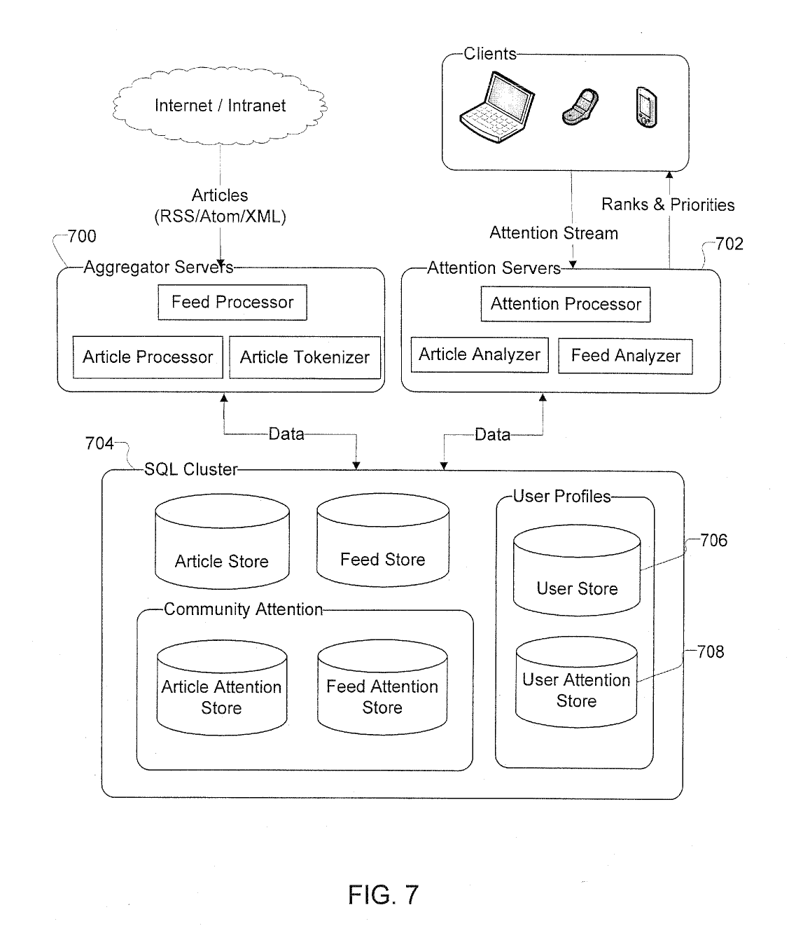

An enterprise version of the software can collect and rank RSS articles across multiple users. FIG. 7 illustrates one preferred embodiment of an enterprise version of the software. This enterprise system uses aggregation servers [700] to collect and process articles. In addition, the system uses attention servers [702] to analyze user attention data and calculate rankings based on the user attention. Another embodiment of the enterprise system contains the aggregation and attention functionality on one server. The system stores the data analyzed by the aggregator servers and attention servers in an SQL Cluster [704]. The SQL Cluster contains attention information for each subscribed user and statistics on each article and feed processed by the software. The SQL Cluster is just one example of a data store that can hold article and feed information. Alternative data stores include an MS Access and Oracle data store. The User Store [706] contains a list of all subscribed users and when they last accessed a feed. The User Attention Store [708] contains a summary of each user's interaction with the software, including the number of feeds the user subscribes to, and the number of articles the user has read, deleted, tagged, emailed, or clicked-through.

The enterprise software allows users to base their rankings on the activities of other users. For example, a user can subscribe to the attention stream of other people or groups; this subscription will modify the user's rankings based on what articles or feeds the other people pay attention to. In one embodiment of the software, the user can subscribe to the top 10 articles of the day or the top 10 feeds of the day.

The enterprise software can also help users identify like-minded peers by determining which users have paid attention to similar articles and feeds. By identifying other likeminded users, the software can help the user find feeds the user has not yet subscribed to, but might find interesting.

User Interface

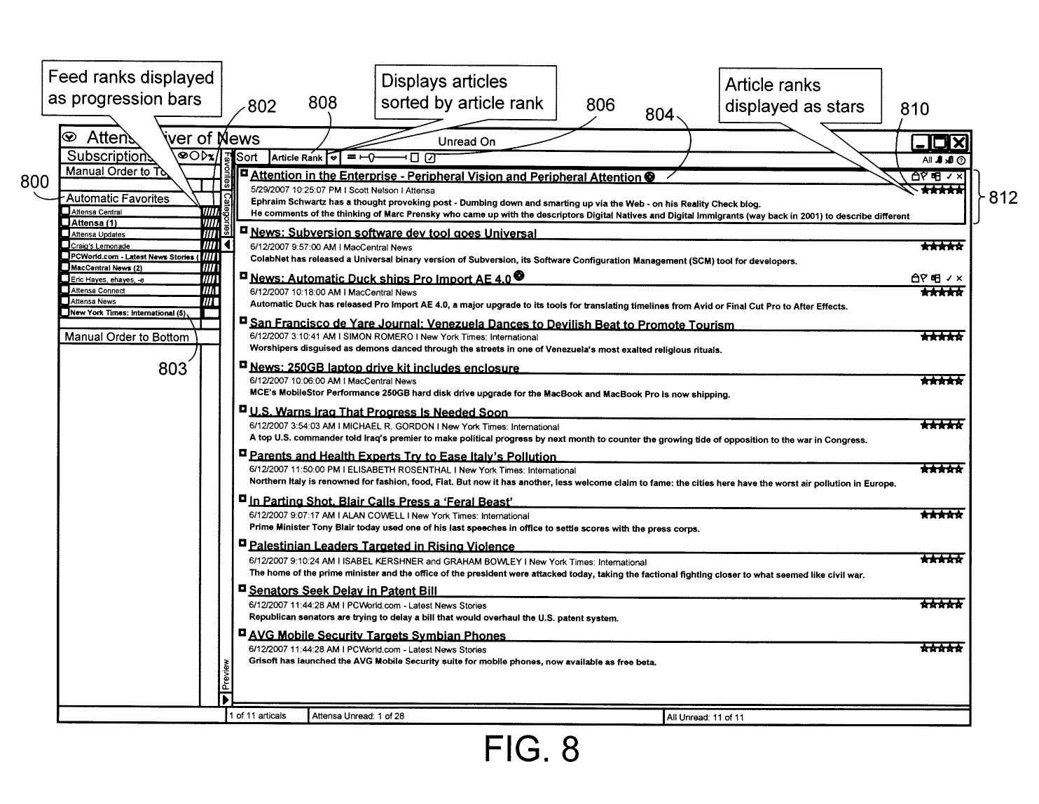

FIG. 8 shows one example of a user interface for an RSS reader client implementing the described enterprise-version ranking system. This interface lists the user's feeds on a left-hand panel [800]. This feed panel can list all the user's feeds or a subset of the users fields. Alternatively, the feed panel can also list the top 10 feeds among all users of the enterprise system. In the preferred embodiment, the progression bars next to each feed [802] show how popular the feed is among all users of the enterprise system, and the feeds are listed in order of that popularity. Alternatively, the feeds on feed panel could be listed in order of their schedule rank or source rank. In the preferred embodiment, the feed panel also shows the number of unread articles for each feed [803].

The RSS articles are listed in the main panel [804]. In the preferred embodiment, the user can choose to list all articles, or just articles from certain feeds. In one embodiment, the user can choose to view the top 10 articles among all users of the enterprise system. The user can also choose to only view unread articles [806]. The user can rank the articles listed in the main panel using a drop-down menu [808]. The drop-down menu will allow the user to rank articles by the article content, source, or schedule.

In the preferred embodiment, each article in the main panel is described by its title, date, time, author, feed source, and short summary. The articles could be presented in alternative ways. For example, each article could be presented only with the title and the first sentence of the content, or with the feed source, author and title. In the preferred embodiment, each article in the main panel also displays its content-based rank through a star-based system [810]. The content rank can also be displayed by color coding each article section [812] in the main panel, where different colors represent different content rankings.

It will be obvious to those having skill in the art that many changes may be made to the details of the above-described embodiments without departing from the underlying principles of the invention. The scope of the present invention should, therefore, be determined only by the following claims.

1. A method for ranking a new article received via a digital content feed, where multiple articles are received from the feed, and each article comprises content and associated metadata, and the method comprising the steps of:
receiving a plurality of articles from the feed;
for each received article, monitoring selected user interactions with the article;
for each monitored user interaction with an article, storing indicia of the user interaction in a data store;
for each stored user interaction with an article, associating the stored user interaction with words that appear in the article content;
detecting a new article received from the feed;
processing the content and metadata of the new article;
analyzing the new article content to form a content-based rank of the new article based on the previously stored user interactions associated with words that appeared in the previously-received articles; and
displaying an indication of the content-based rank of the new article on a display screen.

2. A method for ranking an article according to claim 1 and further comprising:
for each stored user interaction with an article, associating the stored user interaction with at least one element of the metadata associated with the article; and wherein
said analyzing the new article content to form a content-based rank of the new article is also based on comparing at least one element of the metadata associated with the new article to the previously stored user interactions associated with metadata associated with the previously-received articles.

3. A method for ranking an article according to claim 1, wherein
the processing step includes determining the content of the new article, a time the article was received, a day the article was received, and acquiring available metadata that identifies one or more of an author, category, and publisher of the new article.

4. A method for ranking an article according to claim 3, wherein said determining the content of the article includes, for each word in the article:
determining a frequency weight for the word based on the number of occurrences of that word in previously received articles; and
determining an attention weight for the word based on the previously monitored user interactions associated with the word.

5. A method for ranking an article according to claim 4, wherein determining the content includes, for each word, reducing the word if necessary to a root form for analysis based on other occurrences of the same root form.

6. A method for ranking an article according to claim 4, wherein the processing step includes identifying trivial words and preventing any identified trivial words from being used in determining the content.

7. A method for ranking an article according to claim 1 and further comprising:
determining a source rank for the new article based on stored user interactions with the articles previously received from the same feed.

8. A method for ranking an article according to claim 7 wherein the monitored user interactions include at least one of the following:
how many times the article is tagged by the user;
how many times the article is emailed by the user; and
how many times the article is clicked through by the user.

9. A method for ranking an article according to claim 1 wherein:
the article metadata includes at least an author name, a category, and a publisher, and the stored data is analyzed to determine a content-based rank for the article by:
calculating a feed score for the feed that provided the new article, where the feed score is a function of an attention weight of the articles in said feed that arrived prior to the new article;
calculating an author score as a function of an attention weight of the author's name;
calculating a category score as a function of the attention weight of the category;
calculating a publisher score as a function of the attention weight of the publisher;
calculating a title score as a function of the attention weight of the words in title;
calculating a body score as a function of an attention weight of the words in the body of the article; and
calculating the content-based rank as a function of said feed score, author score, category score, publisher score, title score, and body score.

10. A method for ranking an article according to claim 9 wherein each of the feed score, author score, category score, publisher score, title score, and body score are determined as a function of previously monitored user interactions associated other articles previously received on the same feed.

11. A method for ranking an article according to claim 1 including ranking the article with a schedule-based rank, wherein the schedule-based rank is assigned to the feed based on previously acquired and stored data that reflects at least one of:
a percentage of articles in the feed that are read by the user;
a time of the day the feed is read by the user;
day of the week the feed is read by the user; and
delay between the time the article arrives to the time the article is read by the user.

12. A computer-readable medium storing a software reader for managing and displaying articles received on a client device from a digital content feed, the software feed reader comprising:
an aggregator component for collecting and processing the received articles;
an article analyzer component for calculating a content-based rank for each article; and
a client interface for displaying indicia of the received articles on a display screen of the client device in a sequence that is responsive to the content-based rank of each article.

13. A computer-readable medium according to claim 12 wherein the content-based article rank for a given article is based on one or more factors including an article body score that is calculated as a function of attention previously paid by the user to other articles that also include words that appear in the given article's content.

14. A computer-readable medium according to claim 12 wherein the content-based article rank for a given article is based on one or more factors including a body score that is calculated as a function of attention previously paid by the user to other articles from the same feed that also include words that appear in the given article's content.

15. A computer-readable medium according to claim 12 wherein the content-based article rank for a given article is based on one or more factors including at least one type of metadata score that is calculated as a function of attention previously paid by the user to other articles that also include the said type of metadata.

16. A computer-readable medium according to claim 15 wherein the types of metadata scores include a publisher score, a category score and an author score.

17. A computer-readable medium according to claim 12 wherein the content-based article rank for a given article is based on scoring the feed from which the article was received; scoring the author of the article; scoring a category of the article, scoring a publisher of the article, scoring a title of the article, and scoring the article body.

18. A computer-readable medium according to claim 17 wherein said scoring the feed from which the article was received, scoring the author of the article, scoring the category of the article, scoring the publisher of the article, scoring the title of the article, and scoring the article body are each calculated as a function of monitored user interactions with the article.

19. A computer-readable medium according to claim 18 wherein the monitored user interactions include at least one of reading the article, tagging the article and emailing the article.

20. A method for ranking a new article received via a digital content feed in a multi-user, client-server environment, the method comprising the steps of.
registering a plurality of users who each receive articles from selected digital content feeds;
receiving a plurality of articles from the feed;
for each received article, monitoring selected user interactions with the article;
for each monitored user interaction with an article, storing indicia of the user interaction in a data store;
for each stored user interaction with an article, associating the stored user interaction with words that appear in the article content;
detecting a new article received from the feed;
analyzing the new article content to form a content-based rank of the new article based on the previously stored user interactions associated with words that appeared in the previously-received articles; and
displaying an indication of the content-based rank of the new article on a display screen; wherein
the monitored user interactions are those of a predetermined one or more of the registered users, whereby a user can receive rankings of articles based on the actions of other users.
